(19) United States
(12) Patent Application Publication
(10) Pub. No.: US 2016/0323940 A1
(43) Pub. Date: Nov. 3, 2016

(54) METHOD OF CALIBRATING A MULTIFEED RADIO FREQUENCY DEVICE

(71) Applicant: WHIRLPOOL CORPORATION, Benton Harbor, MI (US)

(72) Inventor: Davide Guatta, Benton Harbor, MI (US)

(73) Assignee: WHIRLPOOL CORPORATION, Benton Harbor, MI (US)

(21) Appl. No.: 15/107,595

(22) PCT Filed: Dec. 23, 2013
(86) PCT No.: PCT/US2013/077434

§ 371 Date: Jun. 23, 2016

(51) Int. Cl. H05B 6/70; H05B 6/68; H05B 6/66

(52) U.S. Cl. CPC H05B 6/705; H05B 6/664; H05B 6/68

(57) ABSTRACT

A method for calibrating a device configured to generate at least one radio frequency feed in an enclosed cavity is provided herein. The method is characterized by: selecting at least one subset of frequencies in a bandwidth of the at least one RF feed; setting an input power for the at least one RF feed for each of the at least one subset of frequencies; actuating the at least one RF feed with the input power at each of the subset frequencies; sampling output power data at the at least one RF feed; interpolating the sampled output power data across the bandwidth of the at least one RF feed; and storing the output power data and the interpolated output power across the bandwidth of the at least one RF feed in a look-up table.

### BACKGROUND

A conventional microwave oven cooks food by a process of dielectric heating in which a high-frequency alternating electromagnetic field is distributed throughout an enclosed cavity. A sub-band of the radio frequency spectrum, microwave frequencies at or around 2.45 GHz cause dielectric heating primarily by absorption of energy in water.

To generate microwave frequency radiation in a conventional microwave, a voltage applied to a high-voltage transformer results in a high-voltage power that is applied to a magnetron that generates microwave frequency radiation. The microwaves are then transmitted to an enclosed cavity containing the food through a waveguide. Cooking food in an enclosed cavity with a single, non-coherent source like a magnetron may result in non-uniform heating of the food. To more evenly heat food, microwave ovens include, among other things, mechanical solutions such as a microwave stirrer and a turntable for rotating the food.

### SUMMARY

In one aspect, a method for calibrating a device configured to generate at least one radio frequency (RF) feed in an enclosed cavity is provided. The method is characterized by: selecting at least one subset of frequencies in a bandwidth of the at least one RF feed; setting an input power for the at least one RF feed for each of the at least one subset of frequencies; actuating the at least one RF feed with the input power at each of the subset frequencies; sampling output power data at the at least one RF feed; interpolating the sampled output power data across the bandwidth of the at least one RF feed; and storing the output power data and the interpolated output power across the bandwidth of the at least one RF feed in a look-up table.

### BRIEF DESCRIPTION OF THE DRAWINGS

In the drawings:

FIG. 1 shows a block diagram of an electromagnetic cooking device with multiple coherent RF feeds according to an embodiment;

FIG. 2 shows a block diagram of the small signal RF generator of FIG. 1;

FIG. 3 shows a flowchart describing a method to calibrate the electromagnetic cooking device of FIG. 1;

FIG. 4 shows a deterministic power calibration procedure biased by noise; and

FIG. 5 shows a randomic power calibration procedure according to an embodiment.

### DETAILED DESCRIPTION

A solid-state radio frequency (RF) cooking appliance heats up and prepares food by introducing electromagnetic radiation into an enclosed cavity. Multiple RF feeds at different locations in the enclosed cavity produce dynamic electromagnetic wave patterns as they radiate. To control and shape the wave patterns in the enclosed cavity, the multiple RF feeds may radiate waves with separately controlled electromagnetic characteristics to maintain coherence (that is, a stationary interference pattern) within the enclosed cavity. For example, each RF feed may transmit a different phase and/or amplitude with respect to the other feeds. Other electromagnetic characteristics may be common among the RF feeds. For example, each RF feed may transmit at a common but variable frequency. Although the following embodiments are directed to a cooking appliance where RF feeds direct electromagnetic radiation to heat an object in an enclosed cavity, it will be understood that the methods described herein and the inventive concepts derived herefrom are not so limited. The covered concepts and methods are applicable to any RF device where electromagnetic radiation is directed to an enclosed cavity to act on an object inside the cavity. Exemplary devices include ovens, dryers, steamers, and the like.

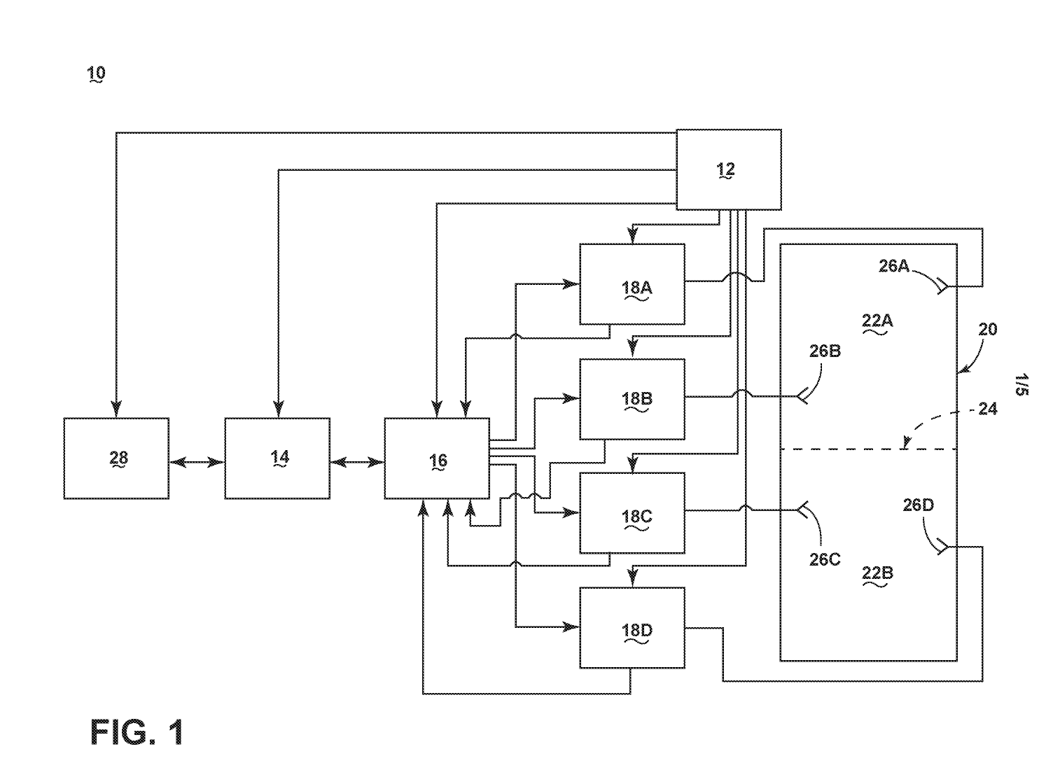

FIG. 1 shows a block diagram of an electromagnetic cooking device 10 with multiple coherent RF feeds 26A-D according to one embodiment. As shown in FIG. 1, the electromagnetic cooking device 10 includes a power supply 12, a controller 14, an RF signal generator 16, a human-machine interface 28 and multiple high-power RF amplifiers 18A-D coupled to the multiple RF feeds 26A-D. The multiple RF feeds 26A-D each couple RF power from one of the multiple high-power RF amplifiers 18A-D into the enclosed cavity 20.

The power supply 12 provides electrical power derived from mains electricity to the controller 14, the RF signal generator 16, the human-machine interface 28 and the multiple high-power RF amplifiers 18A-D. The power supply 12 converts the mains electricity to the required power level of each of the devices it powers. The power supply 12 may deliver a variable output voltage level. For example, the power supply 12 may output a voltage level selectively controlled in 0.5-volt steps. In this way, the power supply 12 may be configured to typically supply 28 volts direct current to each of the high-power RF amplifiers 18A-D, but may supply a lower voltage, such as 15 volts direct current, to decrease an RF output power level by a desired level.

The controller 14 may be included in the electromagnetic cooking device 10, which may be operably coupled with various components of the electromagnetic cooking device 10 to implement a cooking cycle. The controller 14 may also be operably coupled with a control panel or human-machine interface 28 for receiving user-selected inputs and communicating information to a user. The human-machine interface 28 may include operational controls such as dials, lights, switches, touch screen elements, and displays enabling a user to input commands, such as a cooking cycle, to the controller 14 and receive information. The user interface 28 may be one or more elements, which may be centralized or dispersed relative to each other.

The controller 14 may be provided with a memory and a central processing unit (CPU), and may be preferably embodied in a microcontroller. The memory may be used for storing control software that may be executed by the CPU in completing a cooking cycle. For example, the memory may store one or more pre-programmed cooking cycles that may be selected by a user and completed by the electromagnetic cooking device 10. The controller 14 may also receive input from one or more sensors. Non-limiting examples of sensors that may be communicably coupled with the controller 14 include peak level detectors known in the art of RF engineering for measuring RF power levels and temperature sensors for measuring the temperature of the enclosed cavity 20 or one or more of the high-power amplifiers 18A-D.

Based on the user input provided by the human-machine interface 28 and data including the incident and reflected power magnitudes coming from the multiple high-power amplifiers 18A-D (represented in FIG. 1 by the path from each of the high-power amplifiers 18A-D through the RF signal generator 16 to the controller 14), the controller 14 may determine the cooking strategy and calculate the settings for the RF signal generator 16. In this way, one of the main functions of controller 14 is to actuate the electromagnetic cooking device 10 to instantiate the cooking cycle as initiated by the user. The RF signal generator 16 as described below then may generate multiple RF waveforms, that is, one for each high-power amplifier 18A-D based on the settings indicated by the controller 14.

The high-power amplifiers 18A-D, each coupled to one of the RF feeds 26A-D, output a high power RF signal based on a low power RF signal provided by the RF signal generator 16. The low power RF signal input to each of the high-power amplifiers 18A-D may be amplified by transforming the direct current electrical power provided by the power supply 12 into a high power radio frequency signal. For example, each high-power amplifier 18A-D may be capable of outputting a 250-watt RF signal. The maximum output wattage for each high-power amplifier may be more or less than 250 watts depending upon the implementation.

Additionally, each of the high-power amplifiers 18A-D includes a sensing capability to measure the magnitude of the incident and the reflected power levels at the amplifier output. The measured reflected power at the output of each high-power amplifier 18A-D indicates a power level returned to the high-power amplifier 18A-D as a result of an impedance mismatch between the high-power amplifier 18A-D and the enclosed cavity 20. Besides providing feedback to the controller 14 and the RF signal generator 16 to dictate, in part, a cooking strategy, the reflected power level may be significant because excess reflected power may damage the high-power amplifier 18A-D.

Consequently, each high-power amplifier 18A-D may include a dummy load to absorb excessive RF reflections. Along with the determination of the reflected power level at each of the high-power amplifiers 18A-D, temperature sensing at the high-power amplifier 18A-D including at the dummy load may provide the data necessary to determine if the reflected power level has exceeded a predetermined threshold. If the threshold is exceeded, any of the controlling elements in the RF transmission chain including the power supply 12, controller 14, the RF signal generator 16, or the high-power amplifier 18A-D may determine that the high-power amplifier 18A-D may be switched to a lower power level or completely turned off. For example, each high-power amplifier 18A-D may switch itself off automatically if the reflected power level or sensed temperature is too high for several milliseconds. Alternatively, the power supply 12 may cut the direct current power supplied to the high-power amplifier 18A-D.

The multiple RF feeds 26A-D couple power from the multiple high-power RF amplifiers 18A-D to the enclosed cavity 20. The multiple RF feeds 26A-D may be coupled to the enclosed cavity 20 in spatially separated but fixed physical locations. The multiple RF feeds 26A-D may be implemented via waveguide structures designed for low power loss propagation of RF signals. For example, metallic, rectangular waveguides known in microwave engineering are capable of guiding RF power from a high-power amplifier 18A-D to the enclosed cavity 20 with a power attenuation of approximately 0.03 decibels per meter.

The enclosed cavity 20 may selectively include subcavities 22A-B by insertion of an optional divider 24 therein. The enclosed cavity 20 may include on at least one side a shielded door to allow user access to the interior of the enclosed cavity 20 for placement and retrieval of food or the optional divider 24.

The transmitted bandwidth of each of the RF feeds 26A-D may include frequencies ranging from 2.4 GHz to 2.5 GHz. The RF feeds 26A-D may be configured to transmit other RF bands. For example, the bandwidth of frequencies between 2.4 GHz and 2.5 GHz is one of several bands that make up the industrial, scientific and medical (ISM) radio bands. The transmission of other RF bands is contemplated and may include non-limiting examples contained in the ISM bands defined by the frequencies: 13.553 MHz to 13.567 MHz, 26.957 MHz to 27.283 MHz, 902 MHz to 928 MHz, 5.725 GHz to 5.875 GHz and 24 GHz to 24.250 GHz.

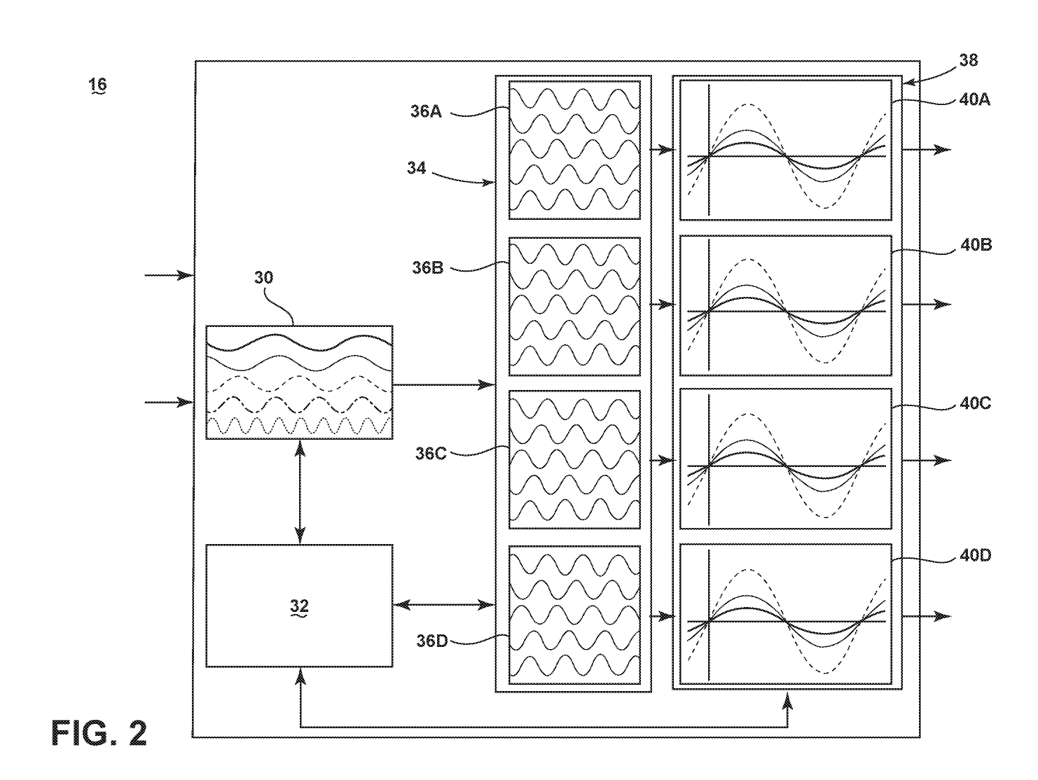

FIG. 2 shows a block diagram of the RF signal generator 16. The RF signal generator 16 includes a frequency generator 30, a phase generator 34 and an amplitude generator 38 sequentially coupled and all under the direction of an RF controller 32. In this way, the actual frequency, phases and amplitudes to be output from the RF signal generator 16 are programmable through the RF controller 32, preferably implemented as a digital control interface. The RF signal generator 16 may be physically separate from the controller 14 or may be physically mounted onto or integrated into the controller 14. The RF signal generator 16 is preferably implemented as a bespoke integrated circuit.

As shown in FIG. 2 the RF signal generator 16 outputs four RF channels 40A-D that share a common but variable frequency (e.g. ranging from 2.4 GHz to 2.5 GHz), but are settable in phase and amplitude for each RF channel 40A-D. The configuration described herein is exemplary and should not be considered limiting. For example, the RF signal generator 16 may be configured to output more or less channels and may include the capability to output a unique variable frequency for each of the channels depending upon the implementation.

As previously described, the RF signal generator 16 may derive power from the power supply 12 and input one or more control signals from the controller 14. Additional inputs may include the incident and reflected power levels determined by the high-power amplifiers 18A-D. Based on these inputs, the RF controller 32 may select a frequency and signal the frequency generator 30 to output a signal indicative of the selected frequency. As represented pictorially in the block representing the frequency generator 30 in FIG. 2, the selected frequency determines a sinusoidal signal whose frequency ranges across a set of discrete frequencies. For example, a selectable bandwidth ranging from 2.4 GHz to 2.5 GHz may be discretized at a resolution of 1 MHz allowing for 101 unique frequency selections.

After the frequency generator 30, the signal is divided per output channel and directed to the phase generator 34. Each channel may be assigned a distinct phase 36A-D, that is, the initial angle of a sinusoidal function. As represented pictorially in the block representing the phase generator 36A-D in FIG. 2, the selected phase of the RF signal for a channel may range across a set of discrete angles. For example, a selectable phase (wrapped across half a cycle of oscillation or 180 degrees) may be discretized at a resolution of 10 degrees allowing for 19 unique phase selections per channel.

Subsequent to the phase generator 34, the RF signal per channel may be directed to the amplitude generator 38. The RF controller 32 may assign each channel (shown in FIG. 2 with a common frequency and distinct phase) to output a distinct amplitude 40A-D. As represented pictorially in the block representing the per channel amplitude generator in FIG. 2, the selected amplitude of the RF signal may range across a set of discrete amplitudes (or power levels). For example, a selectable amplitude may be discretized at a resolution of 0.5 decibels across a range of 0 to 23 decibels allowing for 47 unique amplitude selections per channel.

The amplitude of each channel may be controlled by one of several methods depending upon the implementation. For example, control of the supply voltage of the amplitude generator 38 for each channel may result in an output amplitude for each channel 40A-D from the RF signal generator 16 that is directly proportional to the desired RF signal output for the respective high-power amplifier 18A-D. Alternatively, the per channel output may be encoded as a pulse-width modulated signal where the amplitude level is encoded by the duty cycle of the pulse width modulated signal. Yet another alternative is to coordinate the per channel output of the power supply 12 to vary the supply voltage supplied to each of the high-power amplifiers 18A-D to control the final amplitude of the RF signal transmitted to the enclosed cavity 20.

As described above, the electromagnetic cooking device 10 may deliver a controlled amount of power at multiple RF feeds 26A-D into the enclosed cavity 20. Further, by maintaining control of the amplitude, frequency and phase of the power delivered from each RF feed 26A-D, the electromagnetic cooking device 10 may coherently control the power delivered into the enclosed cavity 20. Coherent RF sources deliver power in a controlled manner to exploit the interference properties of electromagnetic waves. That is, over a defined area of space and duration of time, coherent RF sources may produce stationary interference patterns such that the electric field is distributed in an additive manner. Consequently, interference patterns may add to create an electromagnetic field distribution that is greater in amplitude than any of the RF sources (i.e. constructive interference) or less than any of the RF sources (i.e. destructive interference).

The coordination of the RF sources and characterization of the operating environment (i.e. the enclosed cavity and the contents within) may enable coherent control of the electromagnetic cooking and maximize the coupling of RF power with an object in the enclosed cavity 20. Efficient transmission into the operating environment may require calibration of the RF generating procedure. As described above, in an electromagnetic heating system, the power level may be controlled by many components including the voltage output from the power supply 12, the gain on stages of variable gain amplifiers including both the high-power amplifiers 18A-D and the amplitude generator 38, the tuning frequency of the frequency generator 30, etc. Other factors that affect the output power level include the age of the components, inter-component interaction and component temperature. Consequently, the function describing the output power of the overall RF chain is complex, particularly in a multiple feed RF system, and depends on many variables that may include variables that are not measurable. An RF system to control the power output from multiple RF feeds 26A-D may estimate this function by a calibration procedure and then use the calibration estimate to determine actuation settings for a desired output power level.

Calibration information to describe the output power function may be stored in a look-up table (LUT). A LUT is a data array that replaces runtime computation with a simpler array indexing operation. The LUT may include data that characterizes, per RF feed 26A-D of the multiple feed RF system, the gain of any of the components, an interpolation function, a baseline (or factory settings) calibration for the components, and an updated calibration further refined by an interpolation function, or any combination of these characteristics. In this way, the information in the LUT may identify the relationship between a control variable and the output power of the system. In other words, the LUT describes how control variables like frequency, phase, voltage from the power supply 12 and/or pulse-width modulation affect the output power at the RF feeds 26A-D. Then, when in operation, the controller 14 may determine an optimal output power and invert the relationship described by the LUT to determine the settings for the control variables to achieve the desired output power.

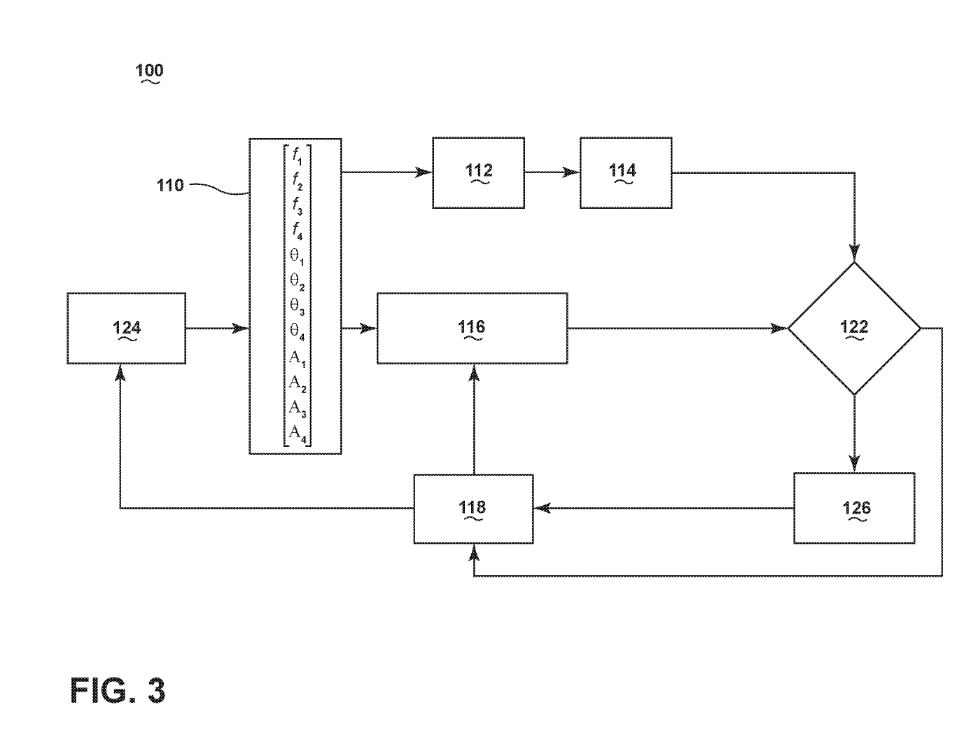

FIG. 3 shows a flowchart describing a method 100 to calibrate the electromagnetic cooking device 10 of FIG. 1. The method 100 exploits measurements of RF power to calibrate the RF feeds 26A-D by forming a LUT that characterizes the relationship between the input settings to the RF signal generator 16 and the actual output power as detected at the RF feeds 26A-D and recorded at the high-power amplifiers 18A-D. A power calibration LUT 118 is an input 124 for the determination of an actuation vector 110 for delivering a particular electromagnetic field distribution within the enclosed cavity 20 to couple RF energy with the object being heated. The controller 14 may determine the vector 110 of RF field actuations by selecting a subset of frequencies in the bandwidth of the RF feeds 26A-D. For example, the controller 14 may select a subset of frequencies that may result in a low reflected power as measured in the RF feeds 26A-D. The controller 14 may then direct the RF signal generator 16 to instantiate the vector 110 and actualize the RF signals by setting an input power for the RF feeds 26A-D for the selected subset of frequencies. The controller 14 may attempt to update the vector 110 at a fast enough rate in order to maximize RF coupling and avoid exposing the high-power amplifiers 18A-D to excess reflected power.

Energy is applied to the enclosed cavity 20 according to the vector 110 describing the frequency, phase, and amplitude that the RF signal generator 16 ascribes to each of the RF channels in the RF chain 112. As described above, the controller 14, the RF signal generator 16, the power supply 12, the high-power amplifiers 18A-D, and the RF feeds 26A-D form the RF chain 112 that delivers a controlled output power 114 to effect an electromagnetic field distribution in the enclosed cavity 20.

An observer (i.e. a logical system that models a real system in order to provide an estimate of the state of the real system) may be implemented to compare the measured output power 114 resulting from the electromagnetic field distribution in the enclosed cavity 20 to a predicted output power 116 based on the current power calibration LUT 118. The measured output power 114 is sampled for RF feeds 26A-D and may be interpolated across the bandwidth of the system to provide data for comparison to the predicted output power 116. If, at 122, the difference between the predicted output power 116 and the measured output power 114 exceeds a predetermined threshold, the controller 14 may initiate a new power calibration procedure 126. In this way, the controller 14 may initiate additional calibration procedures while selecting additional actuation vectors for continuous radiating of the enclosed cavity 20 and its contents.

The comparison may include a direct comparison between the predicted output power 116 and the measured output power 114 or other metrics may be contemplated. For example, if the sum of the differences between the predicted output power 116 and the measured output power 114 over a predetermined time exceeds a predetermined threshold, a new power calibration procedure 126 may be initiated. In this way, the method 100 may advantageously reduce the frequency of initiating a new power calibration procedure 126. Additionally, the comparison 122 and subsequent new power calibration procedure 126 may be applied to all of the RF feeds 26A-D or limited to a single RF feed.

The new power calibration procedure 126 may apply to a subportion of the LUT. For example, the new calibration procedure 126 may apply to certain frequencies, or power supply voltages or RF feeds to reduce the required amount of power calibration test sequences and processing. During a new calibration procedure 126, a controlling element such as the controller 14 may populate the LUT with measurements and then interpolate the measurements to estimate additional elements of the LUT. Input variables may include for example, the per channel RF input, the power supply voltage, the gain on stages of the variable gain amplifiers, the tuning frequency, etc. The output variable is the actual power output 114 measured at one or more of the RF feeds 26A-D of the RF chain 112.

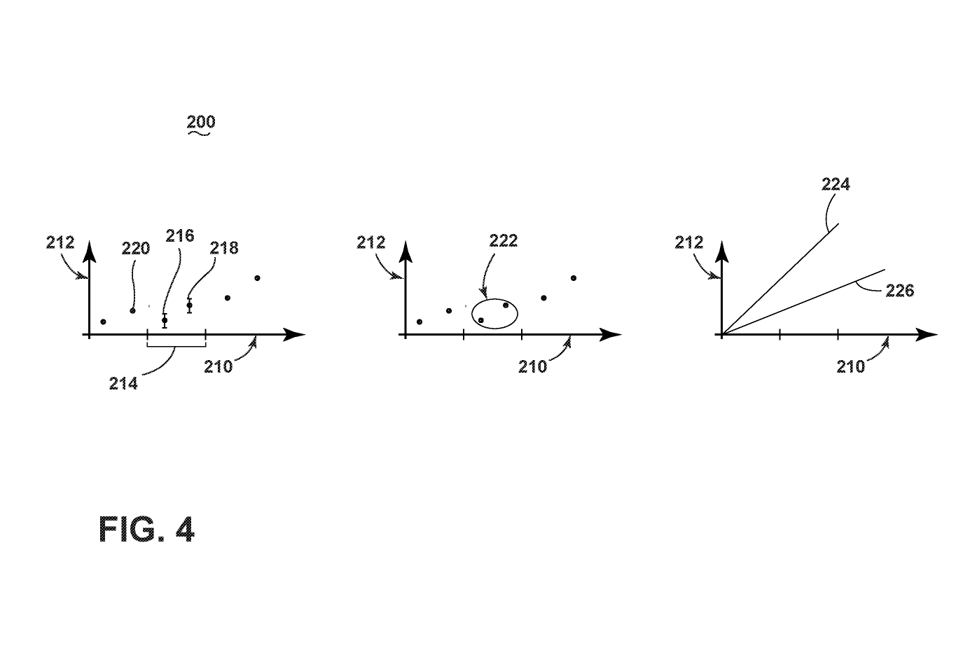

Elements of the LUT may be populated upon powering on the electromagnetic cooking device 10 or adjusted at runtime as the elements of the RF chain 112 heat or otherwise change. Noise sources that affect the elements of the electromagnetic cooking device 10 specifically with respect to the RF chain 112 may be time-dependent and introduce a type of systematic error known as drift. For example, FIG. 4 shows a number of graphs (output power 212 over time 210) illustrating a power calibration procedure 200 biased by noise.

The output power 212 for each of an ordered set of frequencies transmitted by one or more of the RF feeds 26A-D for a given sequence (over time 210) of actuation vectors may follow a function (ideally represented as line 224). As shown in FIG. 4, the measurements for a particular duration of time 214 may be compromised by the noise source. Consequently, the measured power output for the frequencies 216, 218 collected during that time 214 may not be very representative of the ideal measured values (i.e. the measured powers for frequencies 216, 218 are inaccurate). In fact, with a time-dependent noise source, all measurements made in a corrupted time period 222 may have a wide variance or may be biased in a particular way (e.g. all power measurements in the time period are increased). The resulting interpolation 226 may not accurately characterize the input-output relationship of the RF chain 112, that is, the power calibration procedure 200 may result in undesirable amounts of power being delivered to the enclosed cavity 20 for certain frequencies.

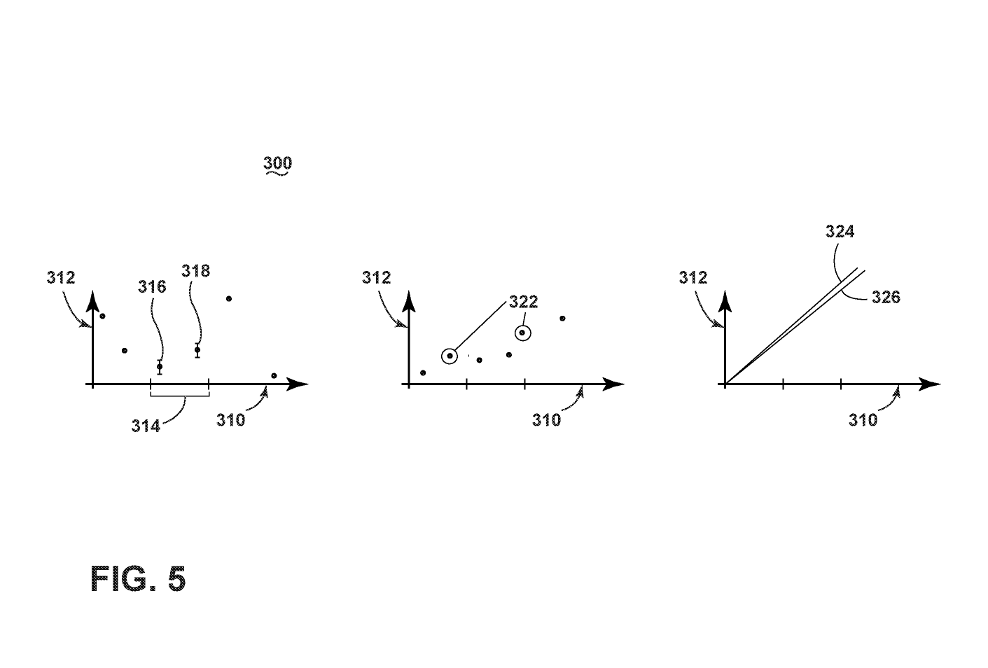

FIG. 5 shows a number of graphs (output power 312 over time 310) illustrating a power calibration procedure 300 where the frequencies are selected randomly. With respect to the execution order of the sampled frequencies, the power calibration sequence 300 may be randomized to mitigate bias. At least one of the RF feeds 26A-D radiates power into the enclosed cavity 20 where the radiated power level follows a predetermined sequence while randomly changing the frequency. For example, the frequencies may be randomly selected according to a uniform distribution across the bandwidth of sampled frequencies. Then the frequencies are transmitted by actuating at least one of the RF feeds 26A-D for an input power level and the output power 312 level may be sampled. For example, if the frequencies f₁, f₂, f₃, f₄, f₅, f₆ represent a set of frequencies arranged in order of increasing frequency, randomly sampling the output power 312 at the RF feeds 26A-D per the power calibration procedure 300 may result in an order of f₄,f₃,f₂,f₅,f₆,f₁. The measurements corrupted in a time period 314 are now separated in frequency. The sampled data may then be sorted in order of increasing frequency prior to interpolation thereby enforcing the separation of corrupted measurements 322. Therefore, if a noise source over the time period 314 affects the sampled frequencies 316, 318, the randomized procedure enables a more robust interpolation 326 which is much closer to the actual characterization 324. The output power data and the interpolated output power across the bandwidth of frequencies may then be stored in the LUT. In this way, the power calibration procedure 300 may be determined by a subset of the overall calibration characterization of the system and still provide an accurate characterization for the parameters not explicitly tested (e.g. the interpolated frequency, power supply voltage, or power levels).

It is contemplated that the present disclosure encompasses at least the following inventive concepts:

### Method of Calibrating Radio Frequency Feeds

1. A method for calibrating a device configured to generate at least one radio frequency (RF) feed in an enclosed cavity, the method characterized by:

radiating the cavity with a predetermined power sequence through the at least one RF feed while randomly changing frequencies of the at least one RF feed;

sampling output power at the at least one RF feed as data; interpolating the sampled output power data across the randomly changed frequencies; and

storing the output power data and the interpolated output power across the bandwidth of the at least one RF feed in a look-up table.

2. The method of 1, wherein the storing includes creating an indexed data array.

3. The method of 1 or 2, further characterized by sorting the sampled power output data before the interpolating step.

4. The method of anyone of 1-3, further characterized by predicting a power output of the at least one RF feed based on the look-up table.

5. The method of 4, further characterized by comparing an actual power output of the at least one RF feed to the predicted power output of the at least one RF feed, and if the comparison exceeds a predetermined threshold, then repeating the radiating, sampling, interpolating and storing steps.

### Method of Calibrating an RF Feed Device

1. A method for calibrating a device configured to generate at least one radio frequency (RF) feed in an enclosed cavity, the method characterized by:

selecting at least one subset of frequencies in a bandwidth of the at least one RF feed;

setting an input power for the at least one RF feed for each of the at least one subset of frequencies;

actuating the at least one RF feed with the input power at each of the subset frequencies;

sampling output power data at the at least one RF feed;

interpolating the sampled output power data across the bandwidth of the at least one RF feed; and

storing the output power data and the interpolated output power across the bandwidth of the at least one RF feed in a look-up table.

2. The method of 1, wherein the storing includes creating an indexed data array.

3. The method of 1 or 2, further characterized by sorting the sampled power output data before the interpolating step.

4. The method of any one of 1-3, wherein the at least one subset of frequencies is selected to heat an object with low reflected power in the enclosed cavity.

5. The method of 4, wherein the object is heated while the sampling, interpolating and storing steps occur.

6. The method of any one of 1-5, further characterized by predicting a power output of the at least one RF feed based on the look-up table.

7. The method of 6, further characterized by comparing an actual power output of the at least one RF feed to the predicted power output of the at least one RF feed, and if the comparison exceeds a predetermined threshold, then repeating the radiating, sampling, interpolating and storing steps.

8. The method of any of 1-7, wherein the at least one RF feed is part of an RF Chain and the look-up table includes at least one of a characterization of gain in the RF chain, a static characterization of the at least one RF feed, or a dynamic characterization of the at least one RF feed.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A method for calibrating a device configured to generate at least one radio frequency (RF) feed in an enclosed cavity, the method comprising:
selecting at least one subset of frequencies in a bandwidth of the at least one RF feed;
setting an input power for the at least one RF feed for each of the at least one subset of frequencies;
actuating the at least one RF feed with the input power at each of the subset frequencies;
sampling output power data at the at least one RF feed;
interpolating the sampled output power data across the bandwidth of the at least one RF feed; and
storing the output power data and the interpolated output power across the bandwidth of the at least one RF feed in a look-up table.

2. The method of claim 1, wherein the storing includes creating an indexed data array.

3. The method of claim 1, further comprising sorting the sampled power output data before the interpolating step.

4. The method of claim 1, wherein the at least one subset of frequencies is selected to heat an object with low reflected power in the enclosed cavity.

5. The method of claim 4, wherein the object is heated while the sampling, interpolating and storing steps occur.

6. The method of claim 1 further comprising predicting a power output of the at least one RF feed based on the look-up table.

7. The method of claim 6, further comprising comparing an actual power output of the at least one RF feed to the predicted power output of the at least one RF feed, and if the comparison exceeds a predetermined threshold, then repeating the radiating, sampling, interpolating and storing steps.

8. The method of claim 1, wherein the at least one RF feed is part of an RF Chain and the look-up table includes at least one of a characterization of gain in the RF chain, a static characterization of the at least one RF feed, or a dynamic characterization of the at least one RF feed.

9. A method for calibrating a device configured to generate at least one radio frequency (RF) feed in an enclosed cavity, the method comprising:
radiating the cavity with a predetermined power sequence through the at least one RF feed while randomly changing frequencies of the at least one RF feed;
sampling output power at the at least one RF feed as data;
interpolating the sampled output power data across the randomly changed frequencies; and
storing the output power data and the interpolated output power across the bandwidth of the at least one RF feed in a look-up table.

10. The method of claim 9, wherein the storing includes creating an indexed data array.

11. The method of claim 9, further comprising sorting the sampled power output data before the interpolating step.

12. The method of claim 9, further comprising predicting a power output of the at least one RF feed based on the look-up table.

13. The method of claim 12, further comprising comparing an actual power output of the at least one RF feed to the predicted power output of the at least one RF feed, and if the comparison exceeds a predetermined threshold, then repeating the radiating, sampling, interpolating and storing steps.
